(19) United States
(12) Patent Application Publication
(10) Pub. No.: US 2026/0361261 A1
(43) Pub. Date: Nov. 12, 2026

(54) NET BASED SOLAR TREE SYSTEM

(71) Applicant: Yonghua Wang, Klamath Falls, OR (US)

(72) Inventor: Yonghua Wang, Klamath Falls, OR (US)

(21) Appl. No.: 18/831,583

(22) Filed: May 12, 2025

(51) Int. Cl. H02S 20/20; H02S 40/38

(52) U.S. Cl. CPC H02S 20/20; H02S 40/38

(57) ABSTRACT

A net based solar tree system for “Forestvoltaic” is designed to convert widely distributed forests on the earth into solar power generation stations. A net based solar tree system comprises: 1) a photovoltaic array of separated small photovoltaic panels with by-pass diodes; 2) a net used to cover a tree or group of trees in a forest; 3) a battery bank with swappable battery modules and a charge controller. Wherein, the separated small photovoltaic panels are distributed and tied on the net and connected with electrical cables; the net is used to cover the tree or trees; and the entire photovoltaic array is electrically connected to the battery bank to charge the battery modules for transport the stored energy to other places.

### TECHNICAL FIELD

The present disclosure relates generally to solar energy conversion and storage system, more specifically, to net based solar tree energy system.

### BACKGROUND

“The sun provides Earth with as much energy every hour as human civilization uses every year. If you are a solar-energy enthusiast, that says it all. No other energy supply could conceivably be as plentiful as the 120,000 terawatts the sun provides ceaselessly and unbidden. If the tiniest fraction of that sunlight were to be captured by photovoltaic cells that turn it straight into electricity, there would be no need to, emit any greenhouse gases from any power plant.” (Oliver Morton, Nature, 443, 19-22 (2006)). However, due to the extremely low energy current density of solar radiation, which is only 1000 w/m² under standard condition, if human being wants to radically address the climate changing and energy depletion issues by completely replacing fossil fuel with solar energy, vast land is needed to collect solar radiation. The conflict of the land uses for power generation and land uses for other purposes will present a grand challenge in front of human being. Agrivoltaic approach provides an excellent example in addressing land use conflict between photovoltaic power generation and agriculture produce production. This approach can be handily extended to forest to form a new approach “Forevoltaic”, which is a combination of forestry and photovoltaics and in this approach the photovoltaic system is co-located over forestry land. However, the conventional Photovoltaic (PV) panels and their installation methods negatively impact the growth of the agricultural products. And the conventional PV panels and their installation methods are not feasible to be co-located over forests to turn forests into solar power generation fields. Forest plays a significant role in environment protection and ecology balance. It is also desired to turn desert into forest. Apparently, innovations in photovoltaic panels and their installation equipments are crucial in addressing the issue of co-locating photovoltaic system over forest and turning forest into solar power generation field.

The present patent discloses a net based solar tree system to cover each of the individual tree or group of trees in a forest with a net based photovoltaic systems to generate electric power and store the generated solar energy, but not to impact the growth of the tree or trees. The system disclosed by the present patent comprises a photovoltaic array of separated small photovoltaic panels with by-pass diodes, a net used to cover a tree or group of trees, and a battery bank with swappable battery modules and a charge controller. Wherein, the separated small photovoltaic panels are distributed and tied on the net and connected with electrical cables; the net is used to cover the tree or trees; and the entire photovoltaic array is connected to the battery bank to charge the battery modules.

The advantage of the system is evident, first of all, the separated small photovoltaic panels allow sunlight to go through the spaces between the photovoltaic panels and reach to the tree or trees to maintain their growth, secondly, the net provides a flexible apparatus for mounting the photovoltaic panels, thirdly, the battery bank with swappable battery modules provides a energy storage system and the swappable battery modules can be harvested to transport the stored energy to other places, and finally, the entire system does not need racks and supports, and therefore, dramatically reduces the cost of the entire system.

### SUMMARY

According to the present invention a net based solar tree system comprises:
1) a photovoltaic array of separated small photovoltaic panels with by-pass diodes; 2) a net used to cover a tree or group of trees in a forest; 3) a battery bank with swappable battery modules and a charge controller.

Wherein, the separated small photovoltaic panels are distributed and tied on the net and connected with electrical cables; the net is used to cover the tree or trees; and the entire photovoltaic array is connected to the battery bank to charge the battery modules.

The advantage of the system is evident, first of all, the separated small photovoltaic panels allow sunlight to go through the spaces between the photovoltaic panels and reach to the tree or trees to maintain their growth, secondly, the net provides a flexible apparatus for mounting the photovoltaic panels, thirdly, the battery bank with swappable battery modules provides a energy storage system and the swappable battery modules can be harvested to transport the stored energy to other places, and finally, the entire system does not need racks and supports, and therefore, dramatically reduces the cost of the entire system.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic indication of the configuration of the net based solar tree system disclosed in the present invention.

FIG. 2 is the configuration of the photovoltaic array of separated small photovoltaic panels with by-pass diodes.

FIG. 3 is the configuration of the battery bank with swappable battery modules and a charge controller.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

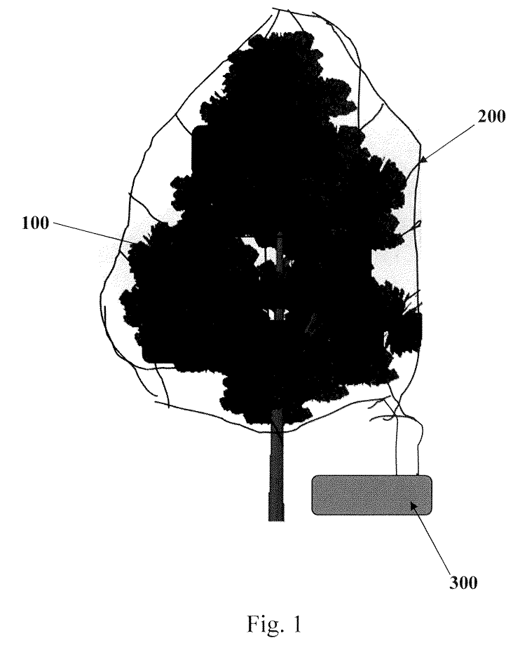

Referring to FIG. 1, the net based solar tree system comprises: 1) a photovoltaic array of separated small photovoltaic panels 100; 2) a net 200 used to cover a tree or group of trees in a forest; 3) a battery bank 300 with swappable battery modules and a charge controller. Wherein the photovoltaic array of separated small photovoltaic panels 100 is tied on the net 200; the net is used to cover the tree or trees in forest; the photovoltaic array is electrically connected to the battery bank 300 to charge the battery.

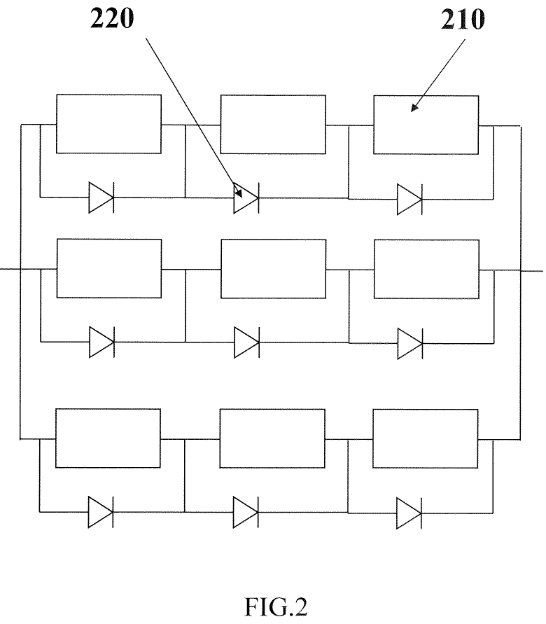

Referring to FIG. 2, photovoltaic array comprises: 1) separated small photovoltaic panels 210; 2) by-pass diodes 220. Wherein, when the group of the photovoltaic is opposite to the sun due to the motion of the sun, the diodes will by-pass currents.

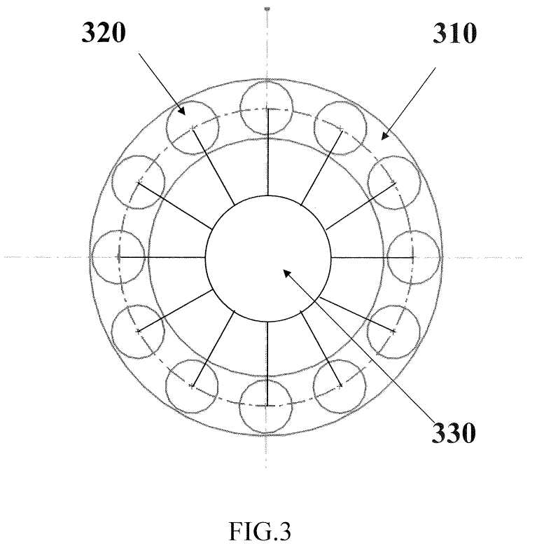

Referring to FIG. 3, the battery bank comprises: 1) the battery bank frame 310; 2) the swappable battery modules 320; and 3) the charge controller 330. Wherein the swappable battery modules can be charged by the photovoltaic array and swapped to transport their stored energy to other places.

The work principle of the net based solar tree system is elucidated as the following. A portion of the sunlight that incidents on the tree or group of trees covered with the net tied with the photovoltaic array of separated small photovoltaic panels is collected and converted into electricity, and the other potion penetrates through the spaces between the separated small photovoltaic panels and arrive to the tree and trees to ensure, their growth. The by-pass diodes by pass the current flow through the separated small photovoltaic panels when they are opposite facet of the tree and trees to the sunlight due to the motion of the sun. The photovoltaic generated electricity is conducted to the battery bank to charge the swappable battery modules, and the charged battery modules are transported to other places for utilizations such as energy replenish of battery swappable electric vehicles.

From the description above, a number of advantages of the net based solar tree system becomes evident. The net provides supports to the photovoltaic array and the separated small photovoltaic panels ensure sufficient solar radiation received by the tree or trees. The by-pass diodes ensure the normal operation of the photovoltaic array during the entire course of a day from morning to evening when the sun is moving. The swappable battery modules address the issue of power storage and power utilization without power grid systems.

Other embodiments of the invention will be apparent to those skilled in the art from consideration of the specification and practice of the invention disclosed herein.

It is intended that the specification and examples be considered as exemplary only, with the true scope and spirit of the invention being indicated by the following claims.

I claim:

1. A net based solar tree system comprises: 1) a photovoltaic array of separated small photovoltaic panels with by-pass diodes; 2) a net used to cover a tree or group of trees in a forest; 3) a battery bank with swappable battery modules and a charge controller;
wherein, the separated small photovoltaic panels are distributed and tied on the net and connected with electrical cables; the net is used to cover the tree or group of trees; and the entire photovoltaic array is electrically connected to the battery bank to charge the battery modules for transporting the stored energy to other places.

2. The photovoltaic array of separated small photovoltaic panels with by-pass diodes of the claim 1, wherein each of the separated small photovoltaic panels is connected with one by-pass diode in parallel.

3. The battery bank with swappable battery modules and a charge controller of the claim 1, wherein the charge controller is electrically connected to each of the swappable battery modules.
